(19) United States
(12) Patent Application Publication
(10) Pub. No.: US 2017/0043413 A1
(43) Pub. Date: Feb. 16, 2017

(54) Workpiece Support with Biocompatible Liner, and Methods of Making and Using Same

(71) Applicant: Southwick & Meister, Inc., Meriden, CT (US)

(72) Inventors: Richard F. Coughlin, Meriden, CT (US); Michael J. Wenning, Meriden, CT (US); David M. Gormley, Meriden, CT (US); James A. Benedetto, Torrington, CT (US)

(73) Assignee: Southwick & Meister, Inc., Meriden, CT (US)

(21) Appl. No.: 15/234,508

(22) Filed: Aug. 11, 2016

Related U.S. Application Data
(60) Provisional application No. 62/205,071, filed on Aug. 14, 2015.
(60) Provisional application No. 62/211,233, filed on Aug. 28, 2015.

(51) Int. Cl. B23B 31/20

(52) U.S. Cl. CPC B23B 31/20; B23B 2222/88; B23B 2222/84; B23B 2228/10; B23B 2240/08; B23B 2240/16; B23B 2240/11; B23B 2231/2027

(57) ABSTRACT

Disclosed herein is workpiece support including a body comprising a radially contractible portion including a plurality of wall sections each having an inner wall surface, the wall sections being separated from one another by slots, and a biocompatible liner comprising a plurality of liner sections fixed to the inner wall surfaces of the plurality of wall sections. An assembly containing the workpiece support, and methods of making and using the workpiece support, also are disclosed.

### FIELD OF THE DISCLOSURE

The disclosure relates to workpiece supports, including collets used to hold parts while being machined, and to bushings used to guide material stock being used to manufacture parts while being machined.

### BACKGROUND

A collet is a holding device—specifically, a subtype of chuck—that forms a collar around the object to be held and exerts a strong clamping force on the object when it is tightened, usually by means of a tapered outer collar. It may be used to hold a workpiece or a tool. Collets are used to hold components of medical devices during machining operations. A bushing is a subtype of machine tool work-holding mechanism that constrains the outer diameter of a round stock material that is being machined into its final shape. During machining, contact between a collet or bushing and part being machined may result in some material from the collet or bushing being deposited onto the part. Components for knee and hip replacement, as well as the screws used to secure these components, are examples of products where residues from machining operations are to be avoided.

Residues on implanted medical device surfaces can result in poor device performance and implant failure. One source of these residues is from materials used in the manufacture of the device, although contamination during the storage, cleaning and handling of the device is also known to occur. Tiny amounts of surface residues can cause deleterious effects in patients, because the residues are in direct contact with body tissues and patients often have compromised immune systems. Also, residues may change the geometry and surface chemistry of the device, so even inert residues can be a problem. For instance, metal residues from contact with a collet or bushing during machine operations may trigger immune response leading to rejection of implanted components.

Implanted medical device components are subject to strict cleanliness standards and are typically subjected to rigorous cleaning and inspection regimens. However, it can be difficult to identify and remove all residue and aggressive cleaning to remove residue can negatively impact surface properties of the implanted component.

There is a need for devices to hold implantable components during manufacture that will not leave deposits of foreign matter on the implantable components.

### SUMMARY

One embodiment described herein is workpiece support including a body comprising a radially contractible portion including a plurality of wall sections each having an inner wall surface, the wall sections being separated from one another by slots, and a biocompatible liner comprising a plurality of liner sections fixed to the inner wall surfaces of the plurality of wall sections.

Another embodiment described herein is an assembly comprising a workpiece support and an implantable device. The workpiece support includes a body comprising a radially contractible portion including a plurality of wall sections each having an inner wall surface, the wall sections being separated from one another by slots, and a biocompatible liner comprising a plurality of liner sections fixed to the inner wall surfaces of the plurality of wall sections. The implantable device is removably mounted in the workpiece support for machining.

A further embodiment is method of making a workpiece support, comprising obtaining a workpiece support blank including a body comprising a radially contractible portion including a plurality of wall sections each having an inner wall surface, the wall sections being separated from one another by slots, and fixing a biocompatible liner comprising a plurality of metal-containing liner sections to the inner wall surfaces of the plurality of wall sections using a process selected from the group consisting of brazing, soldering, welding, and vacuum deposition.

Yet another embodiment is a method comprising obtaining a workpiece support comprising a body having a radially contractible portion including a plurality of wall sections each having an inner wall surface, the wall sections being separated from one another by slots, and a biocompatible liner comprising a first material and including a plurality of liner sections fixed to the inner wall surfaces of the plurality of wall sections, and removably mounting a portion of an implantable device in the workpiece support for machining, the mounted portion of the implantable device comprising the first material.

A collet having a liner made of biocompatible titanium alloy is disclosed. The collet and liner are configured so that the only contact with an implantable component is at the collet liner of biocompatible material. The biocompatible material may be selected to be identical to the material of the implantable component being machined. When the collet liner and component being machined are made of identical material, any residue of the collet liner deposited on the component is indistinguishable from the component itself. This reduces the likelihood that foreign matter on the implantable component from machining operations will trigger rejection or other adverse outcome. The biocompatible-lined collet may also reduce the need to aggressively clean implantable components to remove residue from machining operations.

A bushing having a liner made of bio-compatible alloy also is disclosed. The bushing and liner are configured so that the only contact with an implantable component is at the bushing liner of biocompatible material. The biocompatible material may be selected to be identical to the material of the implantable component being machined. When the bushing liner and component being machined are made of identical material, any residue of the bushing liner deposited on the component is indistinguishable from the component itself. This reduces the likelihood that foreign matter on the implantable component from machining operations will trigger rejection or other adverse outcome. The biocompatible-lined bushing may also reduce the need to aggressively clean implantable components to remove residue from machining operations.

### BRIEF DESCRIPTION OF THE DRAWINGS

FIGS. 1 and 2 are side and right end views of a collet blank after initial machining operations according to aspects of the disclosure, with internal structures shown in broken lines;

FIGS. 3 and 4 are side and right end views of a collet blank after formation of a pocket for the biocompatible insert according to aspects of the disclosure, with internal structures shown in broken lines;

FIG. 5 is a side view of a biocompatible insert according to aspects of the disclosure, with an axial bore shown in broken lines;

FIGS. 6 and 7 are side and right end views of a collet blank and a biocompatible insert brazed in place according to aspects of the disclosure, with internal structures shown in broken lines; and

FIGS. 8 and 9 are side and right end views of a completed collet with biocompatible liner according to aspects of the disclosure.

FIGS. 10 and 11 are side and right end views of a bushing blank after initial machining operations according to aspects of the disclosure, with internal structures shown in broken lines;

FIGS. 12 and 13 are side and right end views of a bushing blank after formation of a pocket for the biocompatible insert according to aspects of the disclosure, with internal structures shown in broken lines;

FIG. 14 is a side view of a biocompatible insert according to aspects of the disclosure, with an axial bore shown in broken lines;

FIGS. 15 and 16 are side and right views of a bushing blank and a biocompatible insert brazed in place according to aspects of the disclosure, with internal structures shown in broken lines;

FIGS. 17 and 18 are side and right end views of a completed bushing with biocompatible liner according to aspects of the disclosure;

FIGS. 19 and 20 are side and right end views of a collet with two wall sections and biocompatible inserts fixed in place according to aspects of the disclosure, with internal structures shown in broken lines; and

FIGS. 21 and 22 are side and right end views of a bushing with two wall sections and biocompatible inserts fixed in place according to aspects of the disclosure, with internal structures shown in broken lines.

### DETAILED DESCRIPTION OF THE DISCLOSED EMBODIMENTS

As used herein, the term “implantable device” refers to a prosthetic device configured to be implanted in the body of a mammal. As used herein, the term “biocompatible” refers to a characteristic of a material or component such that it can be implanted inside the body of a mammal without causing a significant or long-term inflammatory response. A “workpiece” is an object being worked on with a tool or machine.

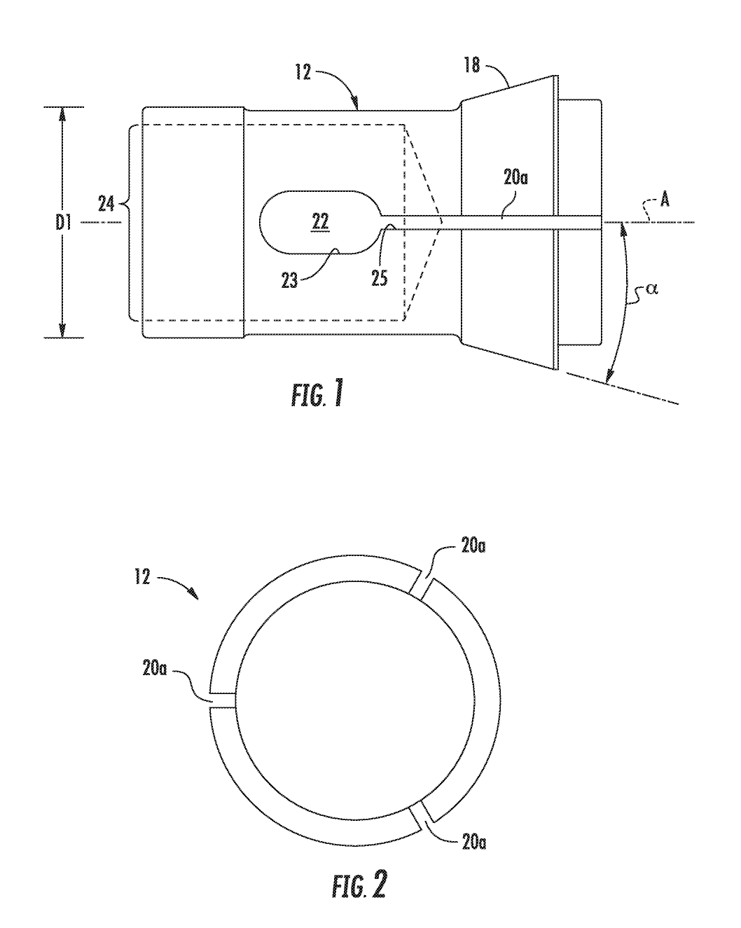

A collet with biocompatible liner and methods of manufacturing will be described with reference to FIGS. 1-9. A collet with biocompatible liner 10 according to the disclosure may be constructed from two components, a collet body 12 and an insert of biocompatible material 14. The insert 14 of biocompatible material is joined to the collet body 12 to form an integral assembly that is subjected to machine, heat treatment, and cleaning operations to produce a finished collet 10. The insert 14 of biocompatible material is placed so that the gripping surfaces 16 of the finished collet 10 consist of material that is identical to the component of an implantable medical device being machined.

Collet manufacture begins with a collet blank 12 (also referred to as the collet body) shown in FIGS. 1 and 2. One embodiment of the collet blank 12 may be AISI E 52100 steel, but other materials may be suitable. The collet blank 12 has a turned profile including a tapered head 18 surrounding what will be an opening for the work piece. Preliminary slots 20a and associated relief openings 22 each defined by a relief wall 23 proximate an interior end 25 of each slot 20a are milled on the outside of the collet blank 12 and a large back bore 24 is made in the tail end of the blank. The oval shape of the relief opening 22 eliminates stress in the collet material during flexure caused by clamping and unclamping work pieces. At this stage of manufacture, the slots 20a and relief openings 22 are milled only part way into the blank 12. Critical dimensions of the blank may include the diameter D1 of the tail of the blank specified by a dimension and +/−tolerance, and the angle a of the tapered head 18 specified by a nominal angle relative to axis A and +/−tolerance from nominal.

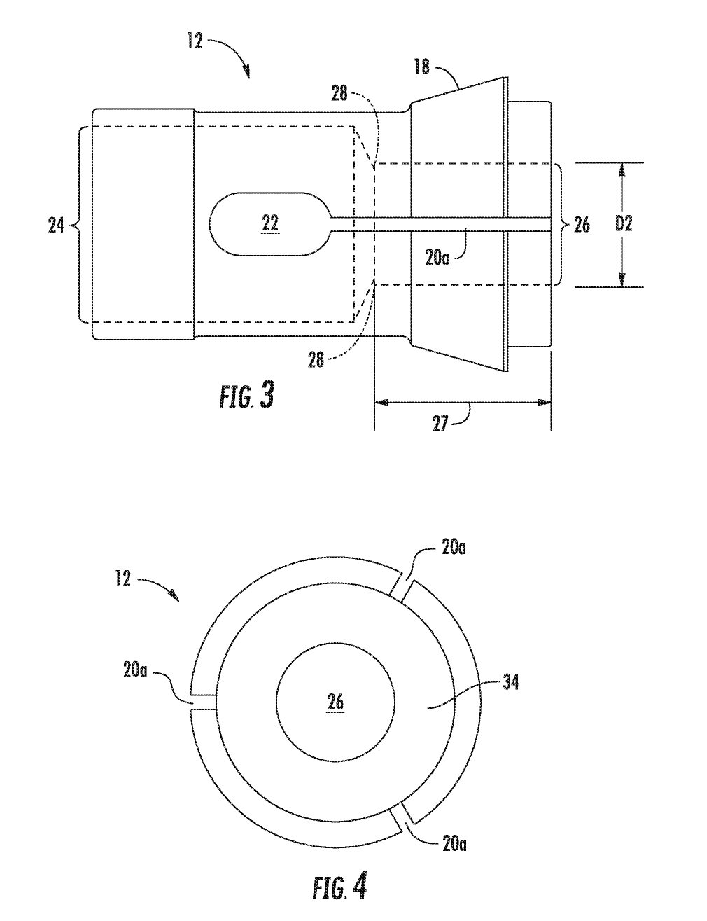

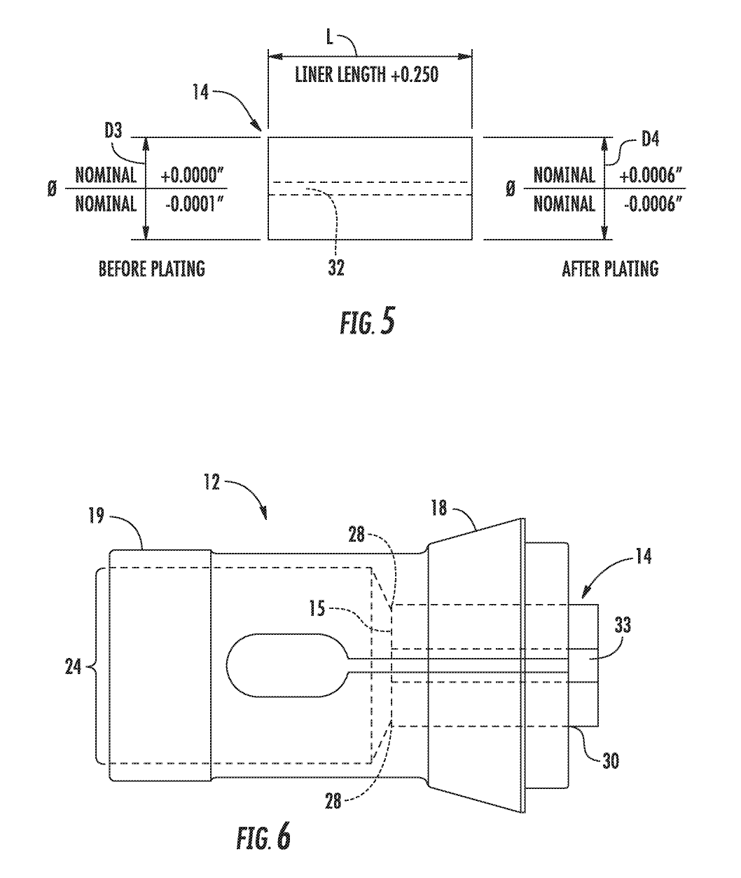

FIGS. 3 and 4 illustrate a collet blank 12 with a pocket 26 bored in the head end to receive the insert 14 of biocompatible material. The pocket 26 is bored from the head end of the blank 12 and leaves a shoulder 28 where the pocket 26 joins the back bore 24 from the tail end of the blank. The pocket 26 is created with a diameter that has a tolerance from nominal of approximately +0.0046″ and nominal +0.0034″. The depth 27 of the pocket corresponds with the length of the biocompatible liner in the finished collet 10. The diameter D2 of the pocket 26 and the diameter (see FIG. 5 at D4) of the biocompatible insert 14 define the braze gap 30 which will be filled with brazing material in a subsequent brazing step.

A cylindrical insert 14 of biocompatible material is prepared from bar stock, as shown in FIG. 5. In embodiments, the biocompatible material comprises titanium. One suitable biocompatible material is Ti6Al7Nb alloy, which is also the material from which the implantable component that will be clamped in the collet is made. There may be suitable biocompatible materials that are not identical to the material of the implantable component to be clamped and such materials are likely to be alloys similar to the material of the implantable component. The biocompatible insert 14 is machined to have a precise outside diameter (OD) D3 no greater than nominal and within −0.0001″ of nominal. The length L of the biocompatible insert 14 is the designed length L2 of the liner in the finished collet plus 0.250″. A pilot hole 32 is drilled along the axis of the biocompatible insert 14 and the insert is plated with a layer of nickel from 0.0002″ to 0.0003″ inches in thickness. The plated biocompatible insert 14 is specified to have a diameter D4+/−0.0006″ relative to the specified (nominal) diameter. In embodiments, other materials can be used, including but not limited to aluminum, copper, silver and gold.

The OD D4 of the plated biocompatible insert 14 and the ID D2 of the pocket 26 define a braze gap 30 that will be filled with brazing material to secure the biocompatible insert 14 into the pocket 26. A braze gap between 0.001″ and 0.002″ and ideally about 0.0015″ results in the best adhesion between the biocompatible insert 14 and the collet blank 12. The braze gap 30 is measured at brazing temperatures of 760° C. and 870° C., when the collet 12 and insert 14 have expanded. The titanium alloy material of the insert 14 has very different thermal properties than the steel substrate collet material. In embodiments, comparing the biocompatible insert alloy made of a titanium alloy to a collet made from steel:
The specific heat capacity of the insert is 3.7 times that of the collet (0.443 BTU/Lb. ° F. for the insert and 0.114 BTU/Lb. ° F. for the collet).
The thermal expansion rate of the insert is 2.4 times that of the collet (16×10^{{-6}}/° F. for the insert and 6.61×10^{{-6}}/° F. for the collet).
The thermal conductivity of the insert is 0.52 times that of the collet (168 BTU.in./h.ft²° F. for the insert and 323 BTU.in./h.ft²° F. for collet).

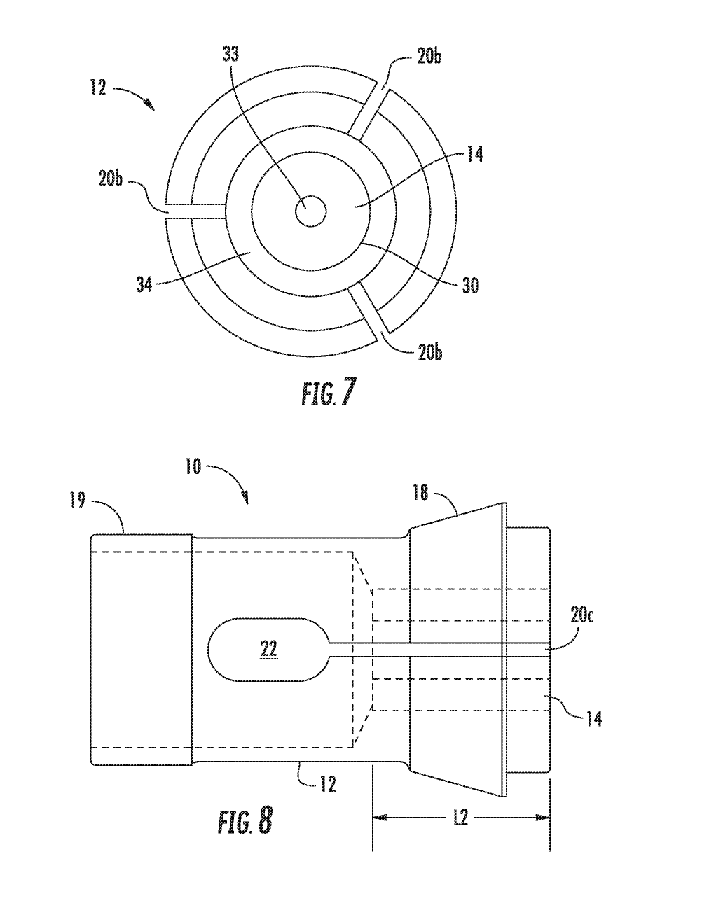

FIGS. 6 and 7 show the biocompatible insert 14 installed in the pocket 26 defined by the collet body 12. The bottom end 15 of the biocompatible insert 14 is seated against the shoulder 28 formed at the junction of the pocket 26 and back bore 24 of the collet body 12. This region is cleaned in a finishing step to eliminate any nickel plating, flux or brazing material that may be present. The original pilot hole 32 (shown in FIG. 5) has been opened to a larger diameter hole 33 configured to receive a center or spindle (not shown) in subsequent operations. The hole 33 in the insert and back bore 24 are used to center the assembled collet/insert 12/14 for a grinding operation that will ensure concentricity of the outside collet surfaces 18, 19 with the axis A of the assembled collet/insert 12/14.

The biocompatible alloy of the insert is relatively soft. The 0.250″ of extra material protruding from the pocket 26 (as shown in FIG. 6) allows for some wear from a spindle or center around which the collet/insert 12/14 assembly is rotated during finish grinding operations. FIG. 7 shows that the three slots 20b have been deepened to remove material prior to a final cutting step that opens the slots completely, as shown in FIG. 9 at 20c. Leaving a ring 34 of collet material surrounding the pocket 26 and insert 14 stabilizes the collet body 12 during boring, brazing, finish grinding, and subsequent manufacturing steps such as hardening of the tapered outside surfaces 18, 19 of the collet body 12.

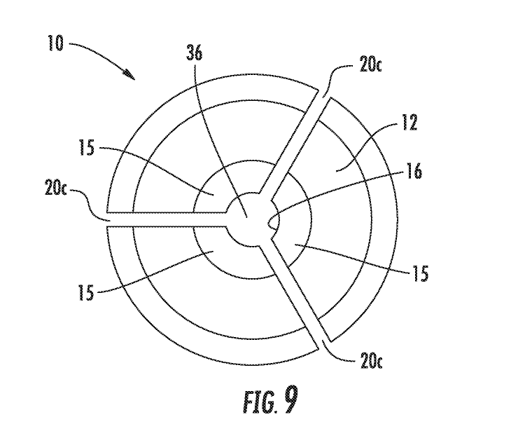

FIGS. 8 and 9 illustrate the collet 10 in its finished configuration. The illustrated collet 10 has three slots 20c and associated relief openings 22 that allow the collet to clamp a work piece inserted in the center opening 36. Other slot configurations are compatible with the disclosed collet with biocompatible liner 10. The center opening 36 of the illustrated collet 10 is defined by circular surfaces, but other opening shapes are commonly used to clamp non-round work-pieces. The center opening 36 may be formed by electrical discharge machining “EDM” using an EDM wire extending through the openings 24, 33 along the axis A of the assembled collet/insert 12/14. Final steps include completing the slots 20c through the ring of collet material 34 and insert 14, thereby forming the liner sections 15, and trimming the excess insert material protruding from the nose end of the collet body 12. The typical collet final assembly manufacturing procedures are then performed until the final inspection has been completed as having been conforming to the inspection criteria.

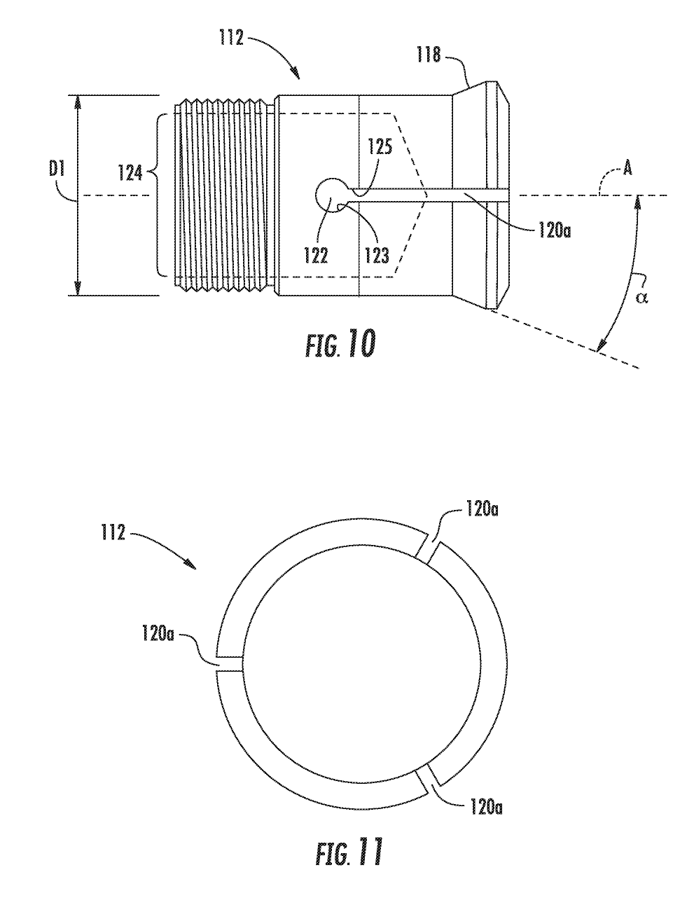

A bushing with biocompatible liner and methods of manufacturing will be described with reference to FIGS. 10-18. A bushing with biocompatible liner 110 according to the disclosure may be constructed from two components, a bushing body 112 and an insert of biocompatible material 114. The insert 114 of biocompatible material is joined to the bushing body 112 to form an integral assembly that is subjected to machine, heat treatment, and cleaning operations to produce a finished bushing 110. The insert 114 of biocompatible material is placed so that the gripping surfaces 116 of the finished bushing 110 consist of material that is biocompatible with the human body.

Bushing manufacture begins with a bushing blank 112 (also referred to as the bushing body) shown in FIGS. 10 and 11. One embodiment of the bushing blank 112 may be AISI 4150 steel, but other materials may be suitable. The bushing blank 112 had a turned profile including a tapered head 118 surrounding what will be an opening for the work piece. Preliminary slots 120a and associated relief opening 122 defined by a relief wall 123 proximate an interior end 125 of each slot 120a are milled on the outside of the bushing blank 112 and a large back bore 124 is made in the tail end of the blank. The round shape of the relief opening 122 eliminates stress in the bushing material during flexure caused by opening and closing the bushing. At this stage of manufacture, the slots 120a and relief openings 122 are milled only part way into the blank 112. Critical dimensions of the blank may include the diameter D1 of the tail of the blank specified by a dimension and +/−tolerance, and the angle a of the tapered head 18 specified by a nominal angle relative to axis A and +/−tolerance from nominal.

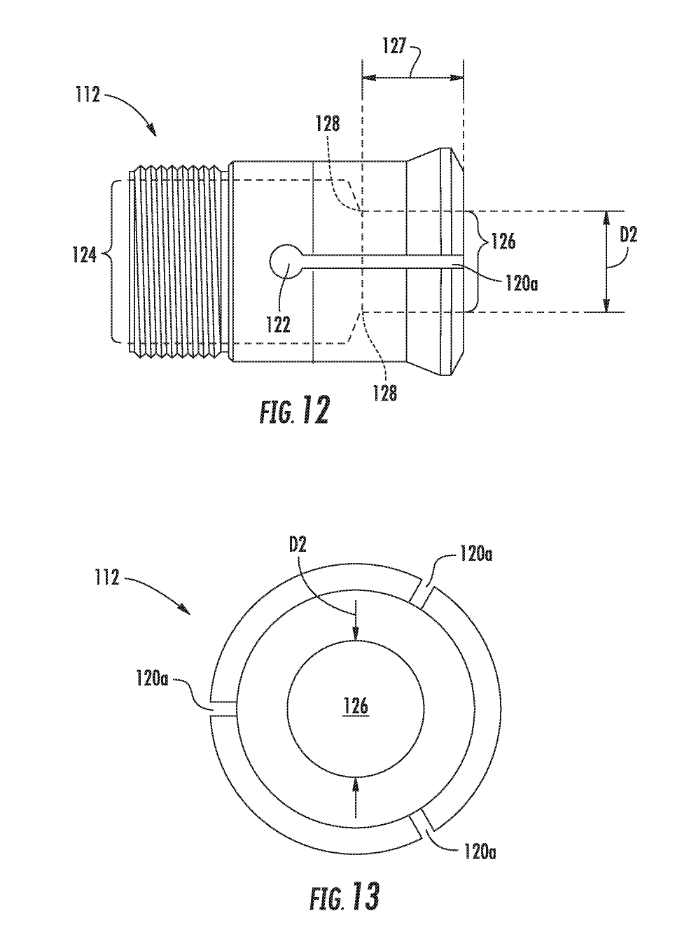

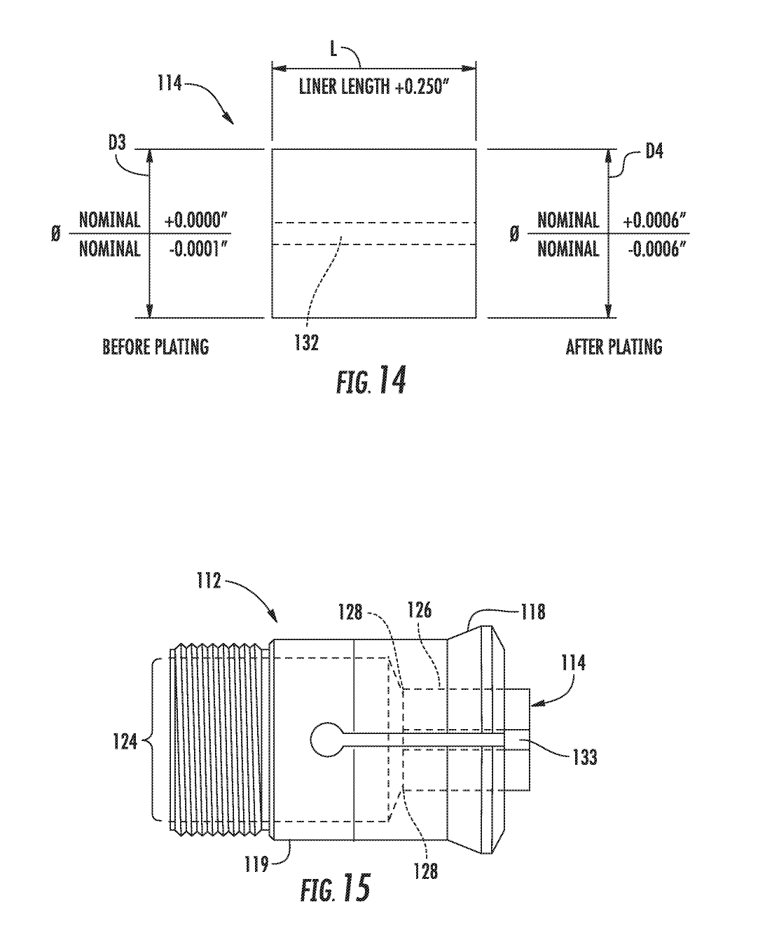

FIGS. 12 and 13 illustrate a bushing blank 112 with a pocket 126 bored in the head end to receive the insert 114 of biocompatible material. The pocket 126 is bored from the head end of the blank 112 and leaves a shoulder 128 where the pocket 126 joins the back bore 124 from the tail end of the blank. The pocket 126 is created with a diameter that has a tolerance from nominal of approximately +0.0046″ and nominal +0.0034″. The depth 127 of the pocket corresponds with the length of the biocompatible liner in the finished bushing 110. The diameter D2 of the pocket 126 and the diameter (see FIG. 14 at D4) of the biocompatible insert 114 define the braze gap 130 which will be filled with brazing material in a subsequent brazing step.

A cylindrical insert 114 of biocompatible material is prepared from bar stock, as shown in FIG. 14. One suitable biocompatible material is Ti6Al7Nb alloy, which is also the material from which the implantable component that will be clamped in the bushing is made. There may be suitable biocompatible materials that are not identical to the material of the implantable component to be guided and such materials are likely to be alloys similar to the material of the implantable component. The biocompatible insert 114 is machined to have a precise outside diameter (OD) D3 no greater than nominal and within −0.0001″ of nominal. The length L of the plus 0.250″. A pilot hole 132 is drilled along the axis of the biocompatible insert 114 and the insert is plated with a layer of nickel from 0.0002″ to 0.0003″ inches in thickness. The plated biocompatible insert 114 is specified to have diameter D4+/−0.0006″ relative to the specified (nominal) diameter.

The OD D4 of the plated biocompatible insert 114 and the ID D2 of the pocket 126 define a braze gap 30 that will be filled with brazing material to secure the biocompatible insert 114 into the pocket 126. A braze gap between 0.001″ and 0.002″ and ideally about 0.0015″ results in the best adhesion between the biocompatible insert 114 and the bushing blank 112. The braze gap 130 is measured at brazing temperatures of 760° C. and 870° C., when the bushing 112 and insert 114 have expanded. The titanium alloy material of the insert 114 has very different thermal properties than the steel substrate bushing material. In embodiments, comparing the biocompatible insert alloy to the bushing alloy:

The specific heat capacity of the insert is 3.7 times that of the bushing (0.443 BTU/Lb. ° F. for the insert and 0.114 BTU/Lb. ° F. for the bushing).

The thermal expansion rate of the insert is 2.3 times that of the bushing (16×10^{{-6}}/° F. for the insert and 7.0×10^{{-6}}/° F. for the bushing).

The thermal conductivity of the insert is 0.54 times that of the bushing (168 BTU.in./h.ft²° F. for the insert and 309 BTU.in./h/ft²° F. for bushing).

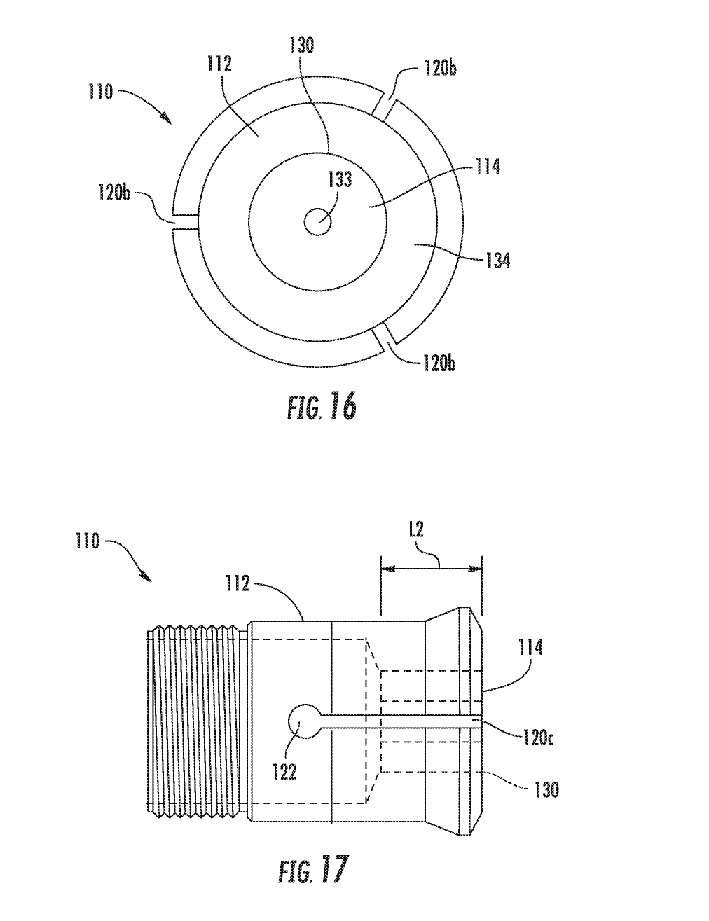

FIGS. 15 and 16 show the biocompatible insert 114 installed in the pocket of 126 defined by the bushing body 112. The bottom end 115 of the biocompatible insert 114 is seated against the shoulder 128 formed at the junction of the pocket 126 and back bore 124 of the bushing body 112. This region is cleaned in a finishing step to eliminate any nickel plating, flux or brazing material that may be present. The original pilot hole 132 (shown in FIG. 14 has been opened to a larger diameter hole 133 configured to receive a center or spindle (not shown) in subsequent operations. The hole 133 in the insert and back bore 124 are used to center the assembled bushing/insert 112/114 for grinding operation that will ensure concentricity of the outside bushing surfaces 118, 119

The biocompatible alloy of the insert is relatively soft. The 0.250″ of extra material protruding from the pocket 126 (as shown in FIG. 15) allows for some wear from a spindle or center around which the bushing/insert 112/114 assembly is rotated during finish grinding operations. FIG. 16 shows that the three slots 120b have been deepened to remove material prior to a final cutting step that opens the slots completely, as shown in FIG. 18 at 20c. Leaving a ring 134 of bushing material surrounding the pocket 126 and insert 114 stabilizes the bushing body 112 during boring, brazing, finish grinding, and subsequent manufacturing steps such as hardening of the tapered outside surfaces 118, 119 of the bushing 112.

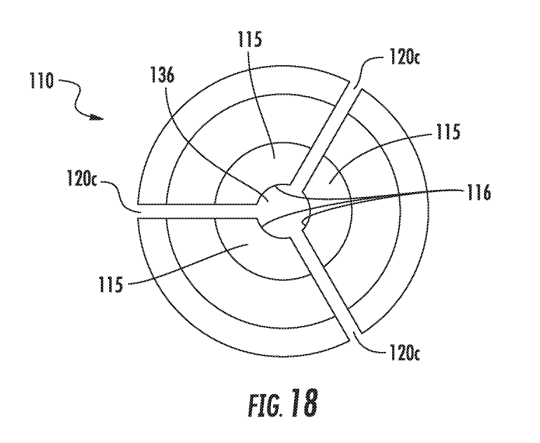

FIGS. 17 and 18 illustrate the bushing 110 in its finished configuration. The illustrated bushing 110 has three slots 120c and associated relief opening 122 that allows the bushing to close in order to guide the component material. Other slot configurations are compatible with the disclosed bushing with biocompatible liner 110. The center opening 136 of the illustrated bushing 110 is defined by circular guiding surfaces 116, but other opening shapes are commonly used for non-round work-pieces. The center opening 136 may be formed by electrical discharge machining “EDM” using an EDM wire extending through the openings 124, 133 along the axis A of the assembled bushing/insert 112/114. Final steps include completing the slots 120c through the ring of bushing material 134 and insert 114, thereby forming the liner sections 115, and trimming the excess insert material protruding from the nose end of the bushing body 112. The typical bushing final assembly manufacturing procedures are then performed until the final inspection has been completed as having been conforming to the inspection criteria.

The biocompatible alloy requires more energy and time to heat than the collet or bushing material, expands much more than the collet or bushing at braze temperature, and conducts heat much more slowly than the steel collet or bushing. Conversely, the collet or bushing material will cool down quickly while extracting heat from the insert, and because the insert will cool off more slowly, the change in dimensions of the insert will occur slowly and the braze alloy will not shear/separate from the collet or bushing surface. Therefore, the cool-down cycle is not as critical as the heat-up cycle.

One brazing alloy that has proven compatible with the disclosed materials is BAg-24, a 50% silver, cadmium free brazing compound. A specifically designed heat schedule for the collet 12 and the insert 14, or the bushing 112 and the insert 114, are performed separately and then in tandem. The parts are heated using induction heating equipment in a manner that is known to those skilled in the art. The pocket ID and liner OD surfaces will be referred to as the faying surfaces in the following brazing steps, which are performed with tools designed to manipulate the heated insert and collet.
Dip both the insert and collet, or the insert and bushing, in the cleansing tray and then the flux tray, within 15 seconds.
Heat the insert to at least 400° C., but not beyond 500° C., within 40 seconds.
Heat the collet or bushing faying area to at least 760° C. but not beyond 870° C., within 40 seconds.
Re-coat both faying surfaces with flux, within 10 seconds.
Coat both faying surfaces with braze alloy and insert the plug into the bore, slightly twist while bottoming out and remove, within 20 seconds
Inspect both faying surfaces, while maintaining the collet or bushing heat at 760 ° C.-870° C., to verify that 100% coverage and adhesion has been attained then re-insert the insert, if not, repeat steps 4-6 again, within 30 seconds
Heat the entire assembly and maintain insert temperature from 705° C. to 720° C., and maintain collet or bushing temperature from 1050° C. to 1100° C., while feeding the top joint with flux and braze alloy, within 10 seconds, remove heat and continue to flux and feed alloy, within 15-30 seconds.
Let the assembled collet/insert or bushing/insert cool to 600° C. in air then place in aluminum pellet tray for two hours.

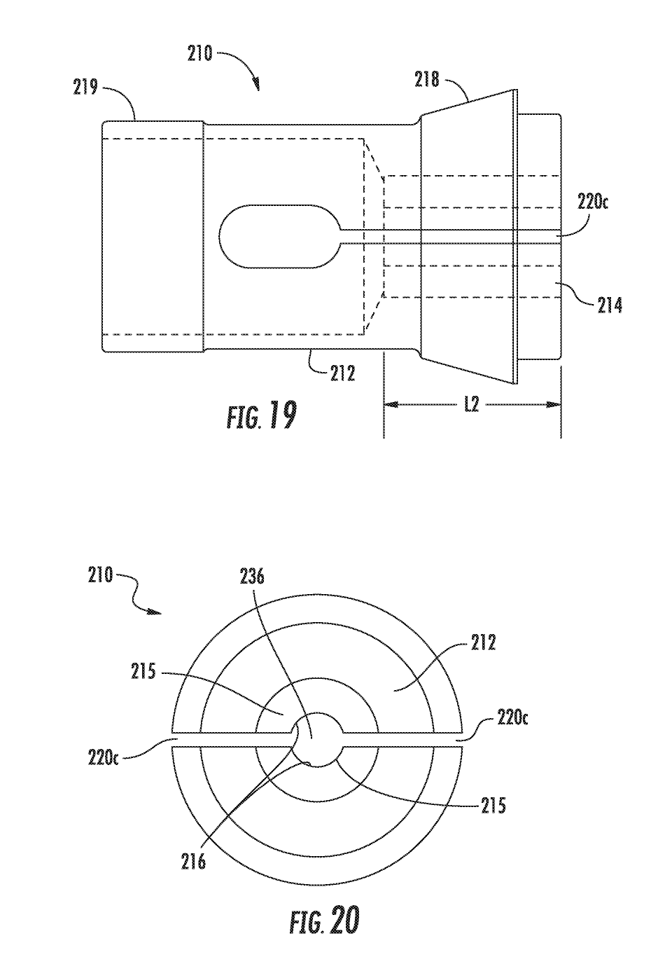

FIGS. 19 and 20 illustrate another embodiment of a collet 210 in its finished configuration. The illustrated collet 210 has two slots 220c and associated relief openings 222 that allow the collet to clamp a work piece inserted in the center opening 236. Other slot configurations are compatible with the disclosed collet with biocompatible liner 210. The center opening 236 of the illustrated collet 210 is defined by circular surfaces, but other opening shapes are commonly used to clamp non-round work-pieces. The center opening 236 may be formed by electrical discharge machining “EDM” using an EDM wire extending through the openings 224, 233 along the axis A of the assembled collet/insert 212/214. Final steps include completing the slots 220c through the ring of collet material 234 and insert 214, thereby forming the liner sections 215, and trimming the excess insert material protruding from the nose end of the collet body 212. The typical collet final assembly manufacturing procedures are then performed until the final inspection has been completed as having been conforming to the inspection criteria.

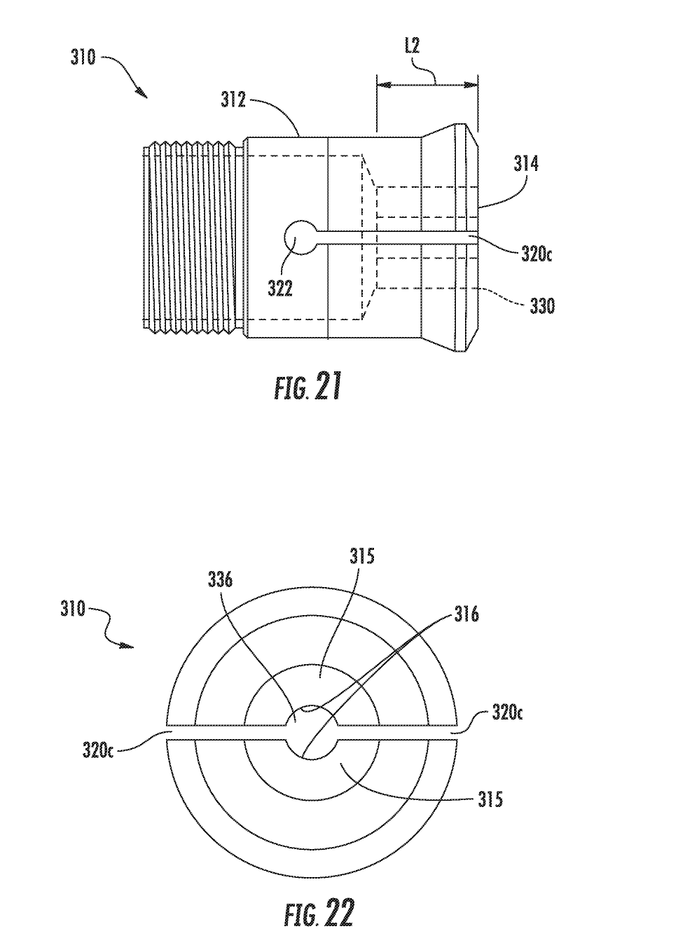

FIGS. 21 and 22 illustrate another embodiment of a bushing 310 in its finished configuration. The illustrated bushing 310 has two slots 320c and associated relief openings 322 that allow the bushing to close in order to guide the component material. Other slot configurations are compatible with the disclosed bushing with biocompatible liner 310. The center opening 336 of the illustrated bushing 310 is defined by circular guiding surfaces 316, but other opening shapes are commonly used for non-round work-pieces. The center opening 336 may be formed by electrical discharge machining “EDM” using an EDM wire extending through the openings 324, 333 along the axis A of the assembled bushing/insert 312/314. Final steps include completing the slots 320c through the ring of bushing material 334 and insert 314, thereby forming the liner sections 315, and trimming the excess insert material protruding from the nose end of the bushing body 312. The typical bushing final assembly manufacturing procedures are then performed until the final inspection has been completed as having been conforming to the inspection criteria.

In embodiments, the workpiece support is employed to support prostheses during machining, including joint prostheses. Non-limiting examples of such joint prostheses include hip, knee and shoulder prostheses. In embodiments, the liner is fixed to the inner wall surfaces of the wall sections by brazing, soldering, welding or vacuum deposition. In some cases, the specific heat capacity (BTU/Lb. ° F.) of the liner is 3-4 times that of the collet body or bushing body. In certain cases, the thermal expansion rate (per ° F.) of the liner is 2.0-2.5 times that of the collet body or bushing body. In some cases, the thermal conductivity (BTU.in./h.ft²° F.) of the liner is 0.4-0.6 times that of the collet body or bushing body.

In embodiments, the wall sections comprise steel, the biocompatible liner comprises titanium, and the liner sections are fixed to the inner wall surfaces of the wall sections using brazing. In embodiments, the entire gripping surface of each liner section is made from the biocompatible material.

A number of alternatives, modifications, variations, or improvements therein may be subsequently made by those skilled in the art, which are also intended to be encompassed by the following claims.

What is claimed is:

1. A workpiece support, comprising:
a body comprising a radially contractible portion including a plurality of wall sections each having an inner wall surface, the wall sections being separated from one another by slots, and
a biocompatible liner comprising a plurality of liner sections fixed to the inner wall surfaces of the plurality of wall sections.

2. The workpiece support of claim 1, wherein the plurality of wall sections are configured to support an implantable device during manufacture of the implantable device.

3. The workpiece support of claim 1, wherein the biocompatible liner includes a plurality of gripping surfaces configured to directly contact an implantable device during manufacture of the implantable device.

4. The workpiece support of claim 2, wherein the biocompatible liner is configured to prevent direct contact between the implantable device and the inner wall surfaces of the plurality of wall sections during use of the workpiece support.

5. The workpiece support of claim 1, wherein the body comprises a collet body.

6. The workpiece support of claim 1, wherein the body comprises a bushing body.

7. The workpiece support of claim 1, wherein each slot has an interior end, and the body includes a relief wall defining an opening adjacent to the interior end of each slot, the opening being configured to facilitate flexure of the radially contractible portion of the body.

8. The workpiece support of claim 1, wherein the radially contractible portion has a generally circular cross section.

9. The workpiece support of claim 1, wherein the biocompatible liner comprises titanium.

10. The workpiece support of claim 9, wherein the inner wall surfaces of the wall sections comprise steel.

11. The workpiece support of claim 10, wherein the biocompatible liner is configured to directly contact an implantable device comprising titanium, and to prevent direct contact between the implantable device and the inner wall surfaces of the plurality of wall sections.

12. An assembly comprising:
a workpiece support, including:
a body comprising a radially contractible portion including a plurality of wall sections each having an inner wall surface, the wall sections being separated from one another by slots, and
a biocompatible liner comprising a plurality of liner sections fixed to the inner wall surfaces of the plurality of wall sections, and
an implantable device removably mounted in the workpiece support for machining.

13. The assembly of claim 12, wherein the implantable device comprises a joint prosthesis.

14. The assembly of claim 12, wherein the biocompatible liner comprises a first material, and the implantable device also comprises the first material.

15. The assembly of claim 12, wherein the biocompatible liner is configured to prevent direct contact between the implantable device and the inner wall surfaces of the plurality of wall sections during use of the workpiece support.

16. The assembly of claim 12, wherein the biocompatible liner includes a plurality of gripping surfaces configured to directly contact the implantable device.

17. The assembly of claim 12, wherein the body comprises a collet body.

18. The assembly of claim 12, wherein the body comprises a bushing body.

19. A method of making the workpiece support of claim 1, comprising obtaining a workpiece support blank including a body comprising a radially contractible portion including a plurality of wall sections each having an inner wall surface, the wall sections being separated from one another by slots, and fixing a biocompatible liner comprising a plurality of metal-containing liner sections to the inner wall surfaces of the plurality of wall sections using a process selected from the group consisting of brazing, soldering, welding, and vacuum deposition.

20. A method comprising:
obtaining a workpiece support comprising a body having a radially contractible portion including a plurality of wall sections each having an inner wall surface, the wall sections being separated from one another by slots, and a biocompatible liner comprising a first material and including a plurality of liner sections fixed to the inner wall surfaces of the plurality of wall sections, and
removably mounting a portion of an implantable device in the workpiece support for machining, the mounted portion of the implantable device comprising the first material.
